(19) United States
(12) Patent Application Publication
(10) Pub. No.: US 2018/0293747 A1
(43) Pub. Date: Oct. 11, 2018

(54) METHOD AND APPARATUS FOR DETERMINING A GEOMETRIC MEASUREMENT VARIABLE OF AN OBJECT

(71) Applicant: Testo SE & Co. KGaA, Lenzkirch (DE)

(72) Inventors: Robert Wulff, Freiburg (DE); Winfried Strittmatter, Freiburg (DE); Thomas Schatzle, Biederbach (DE)

(73) Assignee: Testo SE & Co. KGaA, Lenzkirch (DE)

(21) Appl. No.: 15/946,237

(22) Filed: Apr. 5, 2018

(30) Foreign Application Priority Data
Apr. 5, 2017 (DE) 102017107341.8

(51) Int. Cl. G06T 7/55; G01B 11/02; G06T 19/20; G06T 7/33

(52) U.S. Cl. CPC G06T 7/55; G01B 11/02; G06T 2219/004; G06T 7/344; G06T 19/20

(57) ABSTRACT

A site measuring device (4) for determining a geometric measurement variable of an object (1) based on a three-dimensional model (11) which is stored in a model memory (13) and has a gravity vector (g). The site measuring device (4) has a marking unit (14) that marks a first feature (P0) and a second feature (P1) in the model (11) and a fitting unit (15) that determines a first auxiliary geometry (L0), which contains at least the first marked point feature (P0) and extends parallel to the gravity vector (g), and determines a second auxiliary geometry (E1), which contains at least the second marked feature (P1) and extends perpendicular to the gravity vector (g) and for forming the point of intersection (P2) of the auxiliary geometries (L0, E1). A calculation unit (17) calculates the geometric measurement variable with the aid of the point of intersection (P2).

### INCORPORATION BY REFERENCE

The following documents are incorporated herein by reference as if fully set forth: German Patent Application No. 10 2017 107 341.8, filed Apr. 5, 2017.

### BACKGROUND

The invention relates to a method and to a site measuring device for determining a geometric measurement variable with an unknown feature of an object.

A site measurement of an object, in particular of a building, is required to calculate for example tradesmen's services. During the site measurement, the dimensions of all relevant components and extensions are measured. This is performed generally manually with a measuring stick or measuring tape. Or using a laser distance meter (LDM).

An LDM here has the advantage that many measurements can be taken alone. However, in free corners, a reflector is necessary which must be mounted there in advance or must be held by a helper during the measurement so that the laser does not travel into empty space.

Depending on the object size and complexity, the site measurement in this way is in principle quite demanding in terms of time and staff. In addition, in the case of relatively large objects, such as multi-storey buildings, it may be necessary to set up a scaffold to measure any windows which may be located at the top.

In order to reduce this complexity during the site measurement, there have increasingly been attempts to perform the site measurement on the basis of one or more photos.

It is already known in the prior art to apply a known length reference at the object so as to then take a photo of the object so that the length reference is visible. It is possible in a known camera optical unit, on the basis of the known dimensions, to correct the image in terms of orientation and to reference it. As a result, distances in the image can be measured with centimeter accuracy. The site measurement thereby is significantly faster and easier. In addition, there is a reduced risk that individual distances are omitted and that the object must be visited again in order to perform further measurements. All measurements are determined afterward on the basis of the image.

However, the disadvantage in this photography method is that measurements can be measured only in one plane. If a measurement variable to be measured is not situated in the main plane of the image, it cannot be determined. A further image in this plane is necessary to do so.

For distances or extents that project out of the recording plane, measurement is completely impossible. For example, a balcony which projects perpendicularly from a façade cannot be measured in an image in terms of its depth.

DE 10 2016 002 186 A1 discloses, for example, to calculate a three-dimensional model of an object from images of the object that were recorded from different locations and/or perspectives. On the basis of said three-dimensional model, even such distances can be determined in terms of depth.

However even when recording a plurality of images, some measuring points may always be invisible, a situation that cannot be changed even by changing the camera position. For example, the lower edge of a balcony door on the fourth floor of a building can always be obscured by the balcony itself. In this case, the orientation of the balcony door may not be known even in a three-dimensional model.

### SUMMARY

It is therefore the object of the invention to provide an improved method and an apparatus for determining a geometric measurement variable and/or for supplementing a three-dimensional model with an unknown feature of an object.

This object is achieved by the method and the site measuring device having one or more features of the invention.

The method is essentially based on a three-dimensional model of the object being provided in a modeling step, in which the gravity vector is known. This model can have been created in any desired way, for example in a computer program. The gravity vector indicates in the model the direction of gravity. It therefore points in the direction of gravity and can be used to align the model with respect to gravity.

In a marking step, a first feature and a second feature are then marked in the model, which are related to the geometric measurement variable to be measured. It is possible in this way for the features to be, for example, in each case an endpoint of a measurement variable to be determined, with the other endpoint being unknown.

In a fitting step, a first auxiliary geometry is then determined, which contains at least the first marked feature and extends parallel to the gravity vector, and a second auxiliary geometry is determined, which contains at least the second marked feature and extends perpendicular to the gravity vector, and a point of intersection of the auxiliary geometries is calculated.

Such an auxiliary geometry can be, for example, an auxiliary straight line or an auxiliary plane. Any combination of auxiliary planes and auxiliary straight lines can be used here, that is to say two auxiliary planes, two auxiliary straight lines, or one auxiliary plane and one auxiliary straight line.

In a calculation step, the geometric variable to be determined can be calculated on the basis of the point of intersection of the two auxiliary geometries. The calculated measurement variable can be, for example, a length between two features, although said features do not necessarily have to be the features used to determine the auxiliary geometries.

In addition, the point of intersection can be added like a normal feature to the three-dimensional model, such that it is also available later for further calculations.

The method according to the invention is therefore able to also determine geometric measurement variables that are connected to an unknown feature in the model, in particular end in or start with the unknown feature. The method is particularly suited for determining measurement variables that are perpendicular or parallel to the gravity vector.

In one embodiment of the invention, having independent importance:
a three-dimensional model of the object, in which the gravity vector is known, is provided in a modeling step,
a first feature and a second feature are marked in a marking step in the model,
in a fitting step, a first auxiliary geometry is determined, which contains at least the first marked feature and extends parallel to the gravity vector, and a second auxiliary geometry is determined, which contains at least the second marked feature and extends perpendicular to the gravity vector, and a point of intersection of the auxiliary geometries is calculated, and this point of intersection is included as a feature in the three-dimensional model.

That means that, in contrast to the above-described method, in the fitting step, the point of intersection of the auxiliary geometries is then added like a normal feature to the model, without performing a calculation of a geometric variable. It is hereby possible, for example, to supplement a model that is incomplete due to an obscured feature. However, the feature can also be used for all calculations which are also possible with the other features of the model.

The method according to the invention is also particularly advantageous if the three-dimensional model is first created from individual images. In a development of the invention, in a recording step, a plurality of visual images of the object are recorded using an image recording unit from different positions, and at the same time the alignment of the image recording unit with respect to the gravity vector is stored for each image.

In a modeling step, a three-dimensional model of the recorded object is created from the individual images, wherein the gravity vector of the model is determined from the individual alignments of the images. To create the model, various methods are known in the prior art, which can be used here. What is new, however, is the linking to the gravity vector, which permits alignment of the model with gravity. Only in this way is it possible to correctly fit the auxiliary geometries perpendicularly with respect to one another for determining the obscured features.

The advantage in the method according to the invention is now that even features that are not visible in any of the images can be included in the calculation of geometric variables. This is true in particular if the obscured feature is related to a known feature in a manner such that it is contained in an auxiliary geometry through said known feature.

In an advantageous development of the invention, the method according to the invention is applied only to precise features, in particular point features, which result for example as points of intersection of line features.

In the recognition of features, robust features and precise features can be differentiated. Robust features are features that can be described uniquely in a scene or an image by descriptors in a way such that they are very easily identifiable in other images. Robust features are generally point features. Precise features, on the other hand, are features in the image that are generally easily recognizable for an observer and possibly of interest, such as edges or corners of objects in the image. Precise features are able to be localized substantially more accurately in an image than robust features. However, they are not or only insufficiently identifiable uniquely in further images. The recognition and differentiation of robust and precise features is known in the prior art. Precise features can in particular arise advantageously from points of intersection of lines or edges. Due to the limitation to precise features which are determinable substantially more accurately, increased precision can be achieved during the determination of the geometric variable.

The site measuring device according to the invention for determining a geometric measurement variable with an obscured feature of an object is equipped with
a model memory, in which a three-dimensional model of the object may be stored or is stored and which has a gravity vector,
a display unit for displaying the model,
a marking unit for marking a first feature and a second feature in the model,
a fitting unit for determining a first auxiliary geometry, which contains at least the first marked feature and extends parallel to the gravity vector, and for determining a second auxiliary geometry, which contains at least the second marked feature and extends perpendicular to the gravity vector, and for forming the point of intersection of the auxiliary geometries,
a calculation unit for calculating the distances of the point of intersection from the two marked features.

An alternative site measuring device is equipped with
a model memory, in which a three-dimensional model of the object may be stored or is stored and which has a gravity vector,
a display unit for displaying the model,
a marking unit for marking a first feature and a second feature in the model,
a fitting unit for determining a first auxiliary geometry, which contains at least the first marked feature and extends parallel to the gravity vector, and for determining a second auxiliary geometry, which contains at least the second marked feature and extends perpendicular to the gravity vector, and for forming the point of intersection of the auxiliary geometries, and for adding the point of intersection as a feature to the three-dimensional model.

In addition, this embodiment can have a calculation unit for calculating geometric measurement variables between features of the model.

One advantageous development of the site measuring device is equipped with
an image recording unit for recording a plurality of visual images of the object from different positions,
at least one orientation sensor unit for storing the alignment of the image recording unit with respect to the gravity vector for each image which is stored,
at least one modeling unit for creating a three-dimensional model of the recorded object from the individual images and for determining the gravity vector from the recorded alignments of the individual images.

A three-dimensional model can thereby be created from a plurality of images. Since the gravity vector is available for each image, the model is uniquely alignable with respect to the gravity vector.

### BRIEF DESCRIPTION OF THE DRAWINGS

The invention will be explained in more detail below with reference to a preferred exemplary embodiment with reference to the attached drawings.

In the figures:

FIG. 1 shows a schematic view of a façade with an unknown point feature,

FIG. 2 shows a schematic illustration of the model with auxiliary lines,

FIG. 3 shows a schematic illustration of a façade with a balcony as viewed from the ground,

FIG. 4 shows FIG. 3 with a first auxiliary plane parallel to the gravity vector,

FIG. 5 shows FIG. 4 with a second auxiliary plane perpendicular to the gravity vector,

FIG. 6 shows FIG. 5 with an intersection line of the two auxiliary planes, and

FIG. 7 shows a schematic illustration of a site measuring device according to the invention.

### DETAILED DESCRIPTION OF THE PREFERRED EMBODIMENTS

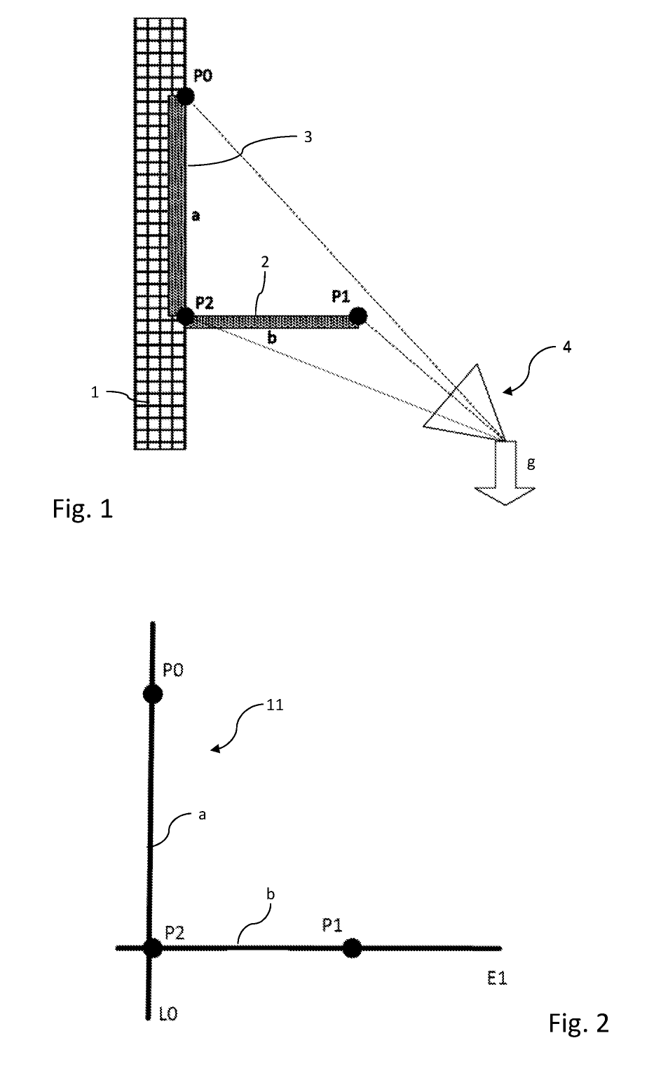

FIG. 1 schematically shows a cross-section of a façade 1 with a balcony 2 and a balcony door 3 arranged in the façade 1. A site measuring device 4 according to the invention is placed in front of the façade 1. To create a three-dimensional model, a plurality of visual images of the façade 1 are recorded using the site measuring device 4.

In the example shown, the recording pose of the site measuring device 4 is such that an upper point P0 of the balcony door 3 and a front point P1 of the balcony 2 can be seen in the image. A lower point P2 of the balcony door 3, however, is obscured by the balcony 2. The point P2 can therefore not be seen in the image.

A model that is created in accordance with a known method on the basis of these images does not contain P2 as a point feature. The point P2 is therefore unknown in the model. Determination of a geometric measurement of the balcony door 3 or of the balcony 2 which proceeds from P2 or contains it is therefore impossible in this model.

The method according to the invention now provides that the gravity vector g is determined during the recording of each image, with said gravity vector describing the orientation of the site measuring device 4 with respect to gravity. Due to the geometric dependencies of the balcony 2 with respect to the façade, the point feature P1 and the point feature P0 are related to the obscured point feature P2.

In order to determine the obscured and unknown point feature P2, the first feature P1 is now selected and a first auxiliary plane E1 is placed through P1, said first auxiliary plane E1 being perpendicular to the gravity vector g. A second auxiliary straight line L0 is placed through the second feature P0 parallel to the gravity vector g. The point of intersection P2 of the two auxiliary geometries L0 and E1 is then formed. Said point of intersection P2 is located where the balcony 2 adjoins the façade 1. It is therefore a good approximation for the unknown point of the balcony door 3.

It is now possible, on the basis of point P2, for example to determine the height a of the balcony door 3 and the depth b of the balcony 2.

In addition to calculating the geometric variables, the point of intersection P2 can be added to the model so as to be available for later and/or other calculations, without the need to perform the selection again.

The three-dimensional model can be created for this calculation in accordance with one of the known methods from the plurality of images. What is important here is only that a gravity vector is available in the model.

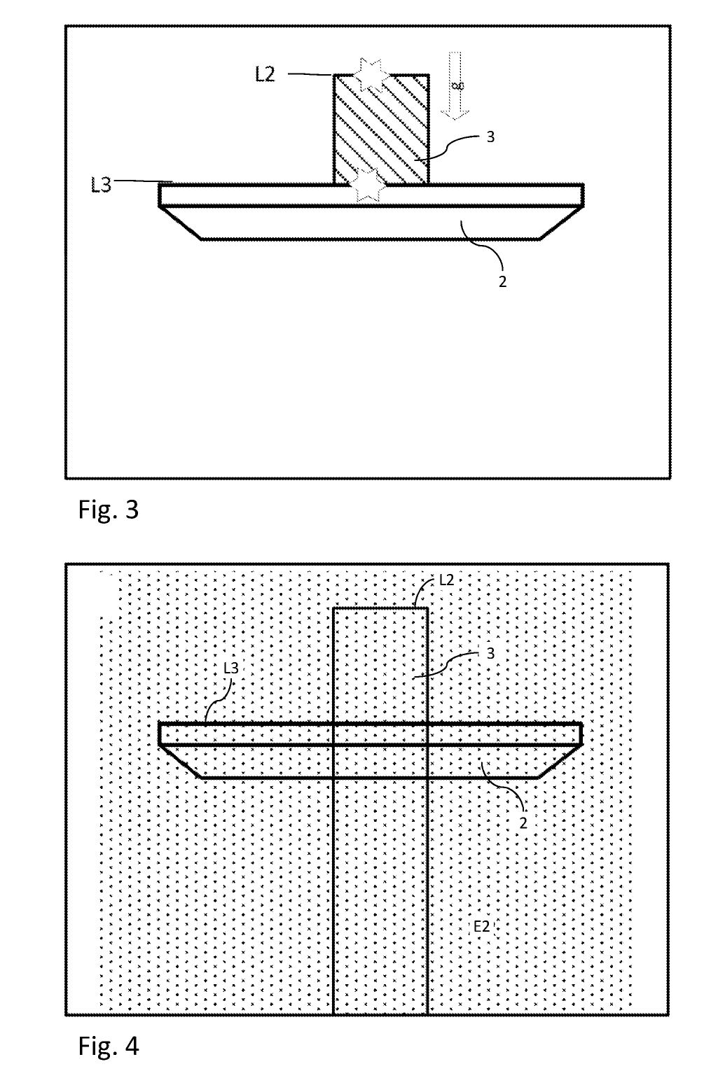

A further variant of the method according to the invention will be explained below with reference to FIGS. 3 to 6. FIG. 3 shows an image of the façade 1, which is also shown in FIG. 1. The image shows the balcony 2 from below. In it, the lower edge of the balcony door 3 is completely obscured by the balcony 2. The balcony door 3 is here generally not located in the plane of the wall, which is why the wall cannot be used as a reference plane to find the obscured edge. Rather, the upper edge L2 of the balcony door 3 is marked in accordance with the invention because said edge is located in the same plane and is therefore related to the required geometric variable.

A first auxiliary plane E2 is now determined (FIG. 4), which is parallel to the gravity vector g and contains the edge L2. The auxiliary plane E2 is thus located in the plane of the balcony door. It is also known from L2 where the upper edge, the right-hand and the left-hand edge of the door are in the plane E2. Only the lower edge of the balcony door 3 is unknown.

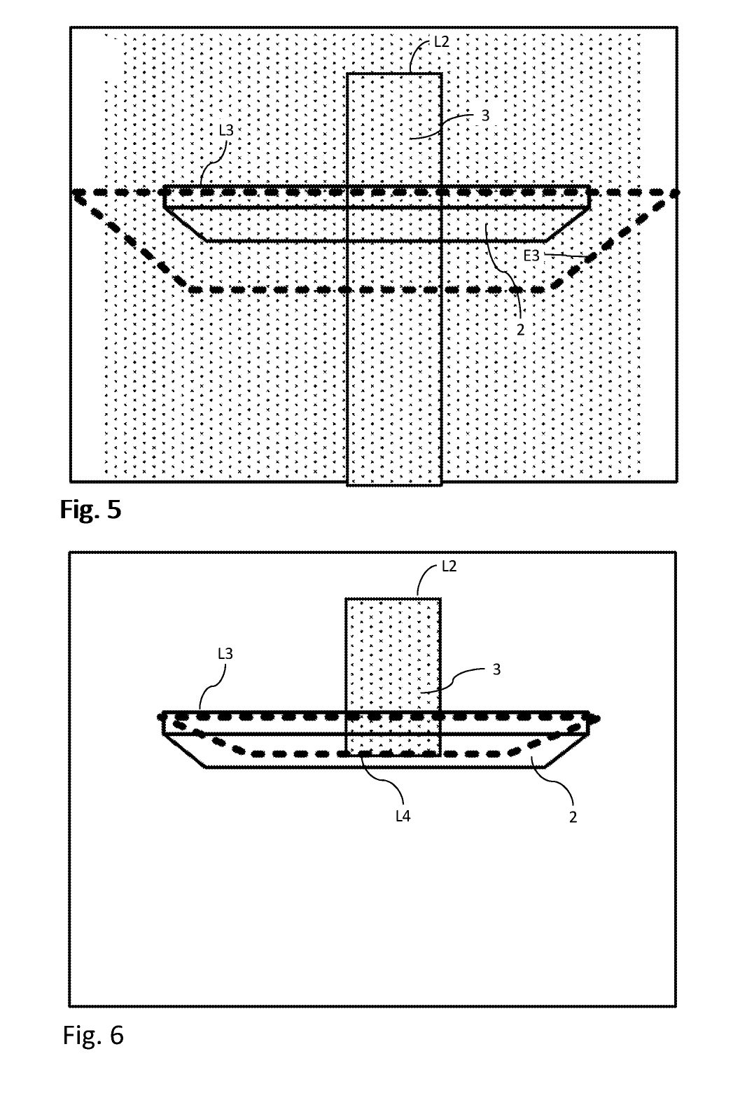

A second auxiliary plane E3 is furthermore calculated (FIG. 5), which is perpendicular to the gravity vector g and contains the front edge L3 of the balcony 2. The front, right-hand and left-hand edges of the balcony slab are also known from L3. Only the rear edge is missing.

Finally, an intersection line L4 is determined from the intersection of the two auxiliary planes E2 and E3 (FIG. 6). This intersection line L4 represents the obscured lower edge of the door 3 and at the same time the rear edge of the balcony slab. The system can therefore automatically create squares in the 3D′ that are located in the respective planes and have the dimensions and positions of the balcony door 3 and the balcony slab.

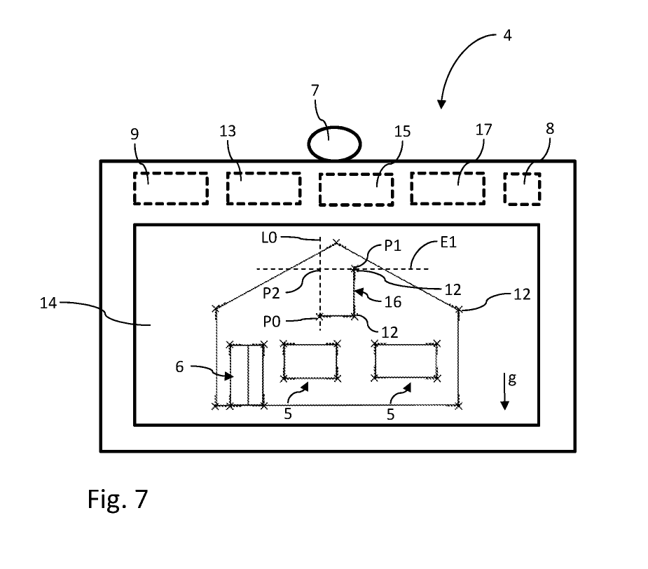

FIG. 7 shows by way of example and schematically a site measuring device 4 according to the invention. The site measuring device 4 has an image recording unit 7 for recording a plurality of visual images of an object from different positions.

The site measuring device 4 furthermore has an orientation sensor 8 for determining the orientation of the image recording unit 7 with respect to the gravity vector. This orientation information can be stored for each image. The orientation sensor 8 can have, for example, one or more linear acceleration sensors and/or a yaw rate sensor and/or a GPS receiver.

The site measuring device 4 has a processor-based modeling unit 9 for creating a three-dimensional model of the recorded object from the individual images. The gravity vector g of the model 11 is also determined here.

The site measuring device according to the invention furthermore has a memory 13 for the models, in which a three-dimensional model 11 of the object may be stored or is stored. The modeling unit 9 can for example store here the model 11 that has been calculated from the images.

The site measuring device 4 in the example furthermore has a screen 14 with a touch-sensitive input function (touchscreen), on which the model 11 and the precise point features 12 may be displayed. The screen also serves as a marking unit for marking precise point features for the method according to the invention.

If a required measurement variable in the model 11, as described in FIGS. 1 and 2, is dependent on an unknown point feature, for example it begins at it or ends in it, the two related features can be selected on the screen.

A processor-based fitting unit 15 then places a first auxiliary geometry, which contains at least the first marked feature and extends parallel to the gravity vector, and a second auxiliary geometry, which contains at least the second marked feature and extends perpendicular to the gravity vector, into the model. The auxiliary geometries and the point of intersection thereof can be interactively displayed on the screen. It is also possible in this way to determine the measurement variables with the unknown feature.

In the example, the left-hand upper corner P2 at the window 16 in the gable is unknown, for example. The right-hand upper corner P1 and the left-hand lower corner P0 can then be selected as the related precise features 12. The fitting unit 15 then determines a first auxiliary straight line L0, which extends parallel to the gravity vector g through P0. And a second auxiliary straight line E1, which extends perpendicular to the gravity vector g through P1. The point of intersection of the two auxiliary geometries corresponds to the required unknown left-hand upper edge P2.

The model memory 13, modeling unit 9, calculation unit 17 and the fitting unit 16, which are drawn separately in FIG. 4, can also be integrated, for example, in a microprocessor, microcontroller or a specially adapted SoC. The invention is therefore not limited in any way to the illustration shown.

The invention describes a site measuring device 4 for determining a geometric measurement variable of an object 1 on the basis of a three-dimensional model 11 which is stored in a model memory 13 and has a gravity vector g, wherein the site measuring device 4 has a marking unit 14 for marking a first feature P0 and a second feature P1 in the model 11 and a fitting unit 15 for determining a first auxiliary geometry L0, which contains at least the first marked feature P0 and extends parallel to the gravity vector g, and for determining a second auxiliary geometry E1, which contains at least the second marked feature P1 and extends perpendicular to the gravity vector g and for forming the point of intersection P2 of the auxiliary geometries L0, E1, wherein a calculation unit 17 for calculating the geometric measurement variable with the aid of the point of intersection P2.

### LIST OF REFERENCE SIGNS

1 façade
2 balcony
3 balcony door
4 site measuring device
5 window
6 door
7 image recording unit
8 orientation sensor unit
9 modeling unit
11 model
13 model memory
14 screen
15 fitting unit
16 window in gable
17 calculation unit
P0 first feature
P1 second feature
P2 point of intersection
L0 first auxiliary straight line
E1 second auxiliary plane
E2 auxiliary plane
E3 auxiliary plane
L2 auxiliary line
L3 auxiliary line
L4 auxiliary line
g gravity vector
a height of the balcony door
b depth of the balcony

1. A method for determining a geometric measurement variable (a, b) of an object (1), comprising:
providing a three-dimensional model (11) of the object (1) in which a gravity vector (g) is known in a modeling step,
in a marking step, marking a first feature (P0) and a second feature (P1) in the model (11), said features being related to the geometric variable to be measured,
in a fitting step, determining a first auxiliary geometry (L0) which contains at least the first feature (P0) that was marked and extends parallel to the gravity vector (g), and determining a second auxiliary geometry (E1) which contains at least the second feature (P1) that was marked and extends perpendicular to the gravity vector (g), and calculating a point of intersection (P2) of the auxiliary geometries,
in a calculation step, calculating the geometric measurement variable (a, b) based on the point of intersection (P2).

2. A method for supplementing a three-dimensional model (11) of an object (1), comprising:
providing a three-dimensional model (11) of the object (1) in which the gravity vector (g) is known in a modeling step,
marking a first feature (P0) and a second feature (P1) in the model (11) in a marking step,
in a fitting step, determining a first auxiliary geometry (L0) which contains at least the first feature (P0) that was marked and extends parallel to the gravity vector (g), and determining a second auxiliary geometry (E1) which contains at least the second feature (P1) that was marked and extends perpendicular to the gravity vector (g), and calculating a point of intersection (P2) of the auxiliary geometries, and including said point of intersection (P2) as a feature in the three-dimensional model (11).

3. The method as claimed in claim 2, further comprising, in a calculation step, calculating a geometric measurement variable (a, b) between two features of the three-dimensional model (11).

4. The method as claimed in claim 1, wherein at least one of the first or second auxiliary geometries in the fitting step is an auxiliary plane or auxiliary straight line.

5. The method as claimed in claim 1, wherein at least one of the first or second features in the marking step is a point feature, a line feature or another identifiable feature.

6. The method as claimed in claim 1, further comprising:
in a recording step, recording a plurality of visual images of the object (1) from different positions using an image recording unit (7), and at a same time storing an alignment of the image recording unit with respect to the gravity vector (g) for each said visual image,
in a modeling step, creating a three-dimensional model (11) of the recorded object (1) from the individual visual images, and determining the gravity vector (g) from an individual alignments of the images.

7. A site measuring device (4) for determining a geometric measurement variable of an object (1), comprising:
a model memory (13), in which a three-dimensional model (11) of the object (1) which has a gravity vector (g) is storable or is stored,
a display unit (14) that displays the model (11),
a processor based marking unit (14) configured to mark a first point feature (P0) and a second point feature (P1) in the model (11),
a processor based fitting unit (15) configured to determine a first auxiliary geometry (L0), which contains at least the first marked feature (P0) and extends parallel to the gravity vector (g), and configured to determine a second auxiliary geometry (E1), which contains at least the second marked feature (P1) and extends perpendicular to the gravity vector (g), and configured to form a point of intersection (P2) of the auxiliary geometries (L0, E1),
a calculation unit (17) configured to calculate the geometric measurement variable based on the point of intersection (P2) of the auxiliary geometries (L0, E1).

8. The site measuring device (4) as claimed in claim 7, wherein the fitting unit (15) is further configured to fit the point of intersection (P2) into the three-dimensional model (11).

9. The site measuring device (4) as claimed in claim 7, wherein the calculation unit (17) is further configured to calculate a geometric measurement variable between features of the three-dimensional model (11).

10. The site measuring device (4) as claimed in claim 7, further comprising:
an image recording unit (7) configured to record a plurality of visual images of the object (1) from different positions,
at least one orientation sensor unit (8) configured to ascertain and store an alignment of the image recording unit (7) with respect to the gravity vector (g) for each said image,
a processor based modeling unit (9) configured to create a three-dimensional model (11) of the recorded object (1) from the individual images and to determine the gravity vector (g) from the recorded alignments of the individual images.
